(19) United States
(12) Patent Application Publication
(10) Pub. No.: US 2013/0301845 A1
(43) Pub. Date: Nov. 14, 2013

(54) EAR PLUG DEVICES, METHODS AND KITS FOR THE INDUCTION AND MAINTENANCE OF QUALITY OF SLEEP

(71) Applicant: Dennis Royal, Fayetteville, NC (US)

(72) Inventor: Dennis Royal, Fayetteville, NC (US)

(21) Appl. No.: 13/726,592

(22) Filed: Dec. 25, 2012

Related U.S. Application Data
(60) Provisional application No. 61/580,282, filed on Dec. 26, 2011.

(51) Int. Cl. G10K 11/175

(52) U.S. Cl. CPC G10K 11/175
USPC 381/71.6; 29/729

(57) ABSTRACT

An ear plug system according to various embodiments can include an ear plug device and an electronic control unit. The ear plug device can be configured to include a white noise component, an ear cover, acupuncture nodes and a headband. The white noise component masks select external noises. The ear cover covers a portion of the user's ear. At least one acupuncture nodules is provided in the ear cover to apply pressure, without penetrating the user's skin. The headband extends at least partially around the user's head and applies compressive force to the ear plug device and the acupuncture nodes to ensure a proper fit and comfort. The electronic control unit wirelessly or directly connects to the ear plug device for controlling the operation of the ear plug device.

### CROSS-REFERENCE TO RELATED APPLICATION

This application claims priority of U.S. Provisional Patent Application Ser. No. 61/580,282, which was filed on Dec. 26, 2011. The subject matter of the earlier filed application is hereby incorporated by reference.

### FIELD

The present teachings relate generally to ear plug devices, methods, and kits for assisting with the induction and maintenance of quality of sleep and non-invasive, electrical stimulation of acupuncture points to provide therapeutic effects during sleep to alleviate symptoms associated with one or more conditions.

### INTRODUCTION

The need for sleep is a fundamental biological function that is as essential to a human as breathing and eating. Sleep is such a fundamental requirement for humans that evidence indicates that sleep is even required for learning. Scientific experts believe little sleep impairs a person's memory, decision making process, social interactions, and ability to concentrate and carry out simple mathematical calculations. Development of hallucinations and mood swings are reported in the case of severe sleep deprivation. A restful sleep usually occurs where a sleeper progresses through a complete sleep cycle, which consists of five sleep stages, and cyclically begins again with stage 1 throughout the night or period of sleep. Rapid Eye Movement (REM) sleep, which is the fifth stage of sleep, is a deeper level of sleep which is necessary to help our brain learn and develop new skills Several beneficiary affects are associated with REM sleep. For example, during REM sleep, the brain processes emotions, memories, and stressful events much clearer. REM sleep allows a person's body to recover from the activities and stressors of the day. Some studies indicate that REM sleep also boosts a person's mood throughout the day. Thus, it is important for a person to maintain an adequate amount of REM sleep for better health and well being.

Unfortunately, noises from automobiles, construction, clock ticking, snoring, and other environmental distractions can hinder a person from enjoying a restful sleep. These noises can interrupt the stages of a sleep cycle and prevent someone from entering into the deeper levels of sleep (REM sleep). Traditionally, ear plugs can be used to block such noises and disturbances. Another technique used to facilitate sleeping is the use of sleep sounds. Because the required amount of sleep varies by individual, the specific sleep sounds that may be used to lull a person to sleep can also vary on an individual basis. Conventional ear plugs do not teach a programmable micro-chip that is positioned within the ear plug and is customizable to deliver user specific soothing sounds in order for the induction and maintenance of quality sleep. Moreover, traditional ear plugs are not retained well within the ear canal of a user, and typically do not include an optional component for blocking out light to further enhance the user's sleep experience. Thus, there is a need for an ear plug device that can be retained within the ear and allow certain user-controlled sounds or light to pass through to promote a restful sleep.

In addition to blocking out sounds, some ear devices are used for therapeutic purposes to stimulate acupuncture points for the treatment of one or more disorders such as obesity, smoking, drug or alcoholism. These conventional ear plug devices however are not directed towards initially creating a restful environment for the induction and maintenance of quality of sleep. Furthermore, these conventional devices are not custom made to be programmed to deliver individual specific therapeutic stimulations. Therefore, it is desirable to provide a micro programmable chip that can be embedded within an ear plug device and programmed to initially create a restful environment that promotes a restful sleep and deliver the therapeutic acupuncture stimulations based on an individual's specific therapeutic needs. It is also desirable to provide ear plug devices that increase the therapeutic effect and offer an effective method of alleviating symptoms of one or more of the above mentioned exemplary disorders.

### SUMMARY

The present invention may satisfy one or more of the above-mentioned desirable features. Other features and/or advantages may become apparent from the description which follows.

An ear plug system according to various embodiments can include an ear plug device and an electronic control unit. The ear plug device can be configured to include a white noise component, an ear cover, acupuncture nodes and a headband. The white noise component enhances a user's concentration and creates a restful environment by masking select external noises. The ear cover covers a portion of the user's ear and attaches to the ear plug device. The acupuncture nodules are provided in the ear cover to apply pressure, without penetrating the user's skin, to provide therapeutic effects to stimulate acupuncture points to provide relief of symptoms associated with certain conditions. The acupuncture nodules can be applied using pressure, infrared or vibration treatment. The headband extends at least partially around the user's head and applies a compressive force to the ear plug device and the acupuncture nodes to ensure a proper fit and comfort. The electronic control unit wirelessly or directly connects to the ear plug device for controlling the operation of the ear plug device.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

### BRIEF DESCRIPTION OF THE DRAWINGS

The skilled artisan will understand that the drawings described below are for illustrative purposes only. The drawings are not intended to limit the scope of the present teachings in any way.

FIG. 1 is an expanded view of an exemplary embodiment of components of an ear device system in accordance with the present teachings;

FIGS. 2A-2D illustrate an exemplary embodiment of the ear plug device in accordance with the present teachings;

FIGS. 3A-3B illustrate an electronic unit that can be employed with the ear device system;

FIG. 4 is an ear acupuncture pressure point chart;

FIG. 5A-5B illustrate an embodiment of the ear plug device including a plurality of acupuncture nodules;

FIGS. 6A-6C illustrate an embodiment of the ear plug device including a plurality of acupuncture nodules;

FIGS. 6D-6E illustrate a sectional view of circle a in FIG. 6B;

FIGS. 7-8 illustrate various ear plug device including a plurality of acupuncture nodules;

FIGS. 9A-9B illustrate a wireless electronic control unit that can be employed to control the ear device system of the present teachings;

FIGS. 10A-10C illustrate ear plug devices having various configurations according to the present teachings;

FIGS. 11A-11B illustrate ear plug devices having various configurations according to the present teachings;

FIG. 12 illustrates a headband in use with the ear device system;

FIGS. 13A-13B illustrate a user wearing the device in use with a headband; and

FIGS. 13C-13D illustrate a user wearing the device in use with a visor.

### DETAILED DESCRIPTION OF VARIOUS EMBODIMENTS

Reference will now be made to various embodiments, examples of which are illustrated in the accompanying drawings. However, these various exemplary embodiments are not intended to limit the disclosure. On the contrary, the disclosure is intended to cover alternatives, modifications, and equivalents.

Throughout the application, description of various embodiments may use “comprising” language, however, it will be understood by one of skill in the art, that in some specific instances, an embodiment can alternatively be described using the language “consisting essentially of or “consisting of.”

For purposes of better understanding the present teachings and in no way limiting the scope of the teachings, it will be clear to one of skill in the art that the use of the singular includes the plural unless specifically stated otherwise. Therefore, the terms “a,” “an” and “at least one” are used interchangeably in this application. Unless otherwise indicated, all numbers expressing quantities, percentages or proportions, and other numerical values used in the specification and claims, are to be understood as being modified in all instances by the term “about.”

Various embodiments of the ear plug system described herein provides a restful sleep environment that enables the user to enter a deep level of sleep, such as REM sleep. Various embodiments of the ear plug system provides an electronic, remote controlled ear plug device that enables the user to control the type of sounds that creates the restful environment, while blocking out extraneous, external noise. In various embodiments, the ear plug system may mask external noises using, for example, a white noise component in order to enhances the user's concentration and create the restful environment by masking select external noises as controlled by the user. In addition, in various embodiments, the ear plug device can further be configured to produce soothing sounds, such as music, ocean waves, rain, and wind.

Various embodiments combine an ear plug device with acupuncture nodule configurations to apply pressure, without penetrating the skin, to provide therapeutic effects to stimulate acupuncture points to provide relief of the symptoms of certain conditions. In some embodiments, the acupuncture nodules can be integrally designed within the ear plug device. In other embodiments, the acupuncture nodules can be configured within a removable ear cover mechanism attached to the ear plug device. The ear cover mechanism may be designed to cover a portion of the user's ear or substantially the entire front of the user's ear. In an electronic embodiment, the ear plug system may provide programmable settings that can be controlled by the user to apply pressure to one or more particular pressure points of the body that are associated with a disease or disorder that the user desires to provide therapy thereto. In various embodiments, the therapeutic acupuncture nodule configurations can be applied using pressure, infrared or vibration treatment.

In various embodiments, secure retention of the ear plug device and the acupunctures nodes can be provided by a compressive headband that extends at least partially around the user's head. Various embodiments combine the headband with a visor, shade, or shield to block out external light and to further create the restful environment. In an electronic embodiment, the shade or visor can be remote controlled activated to adjust the amount of light permitted to penetrate the shade or visor.

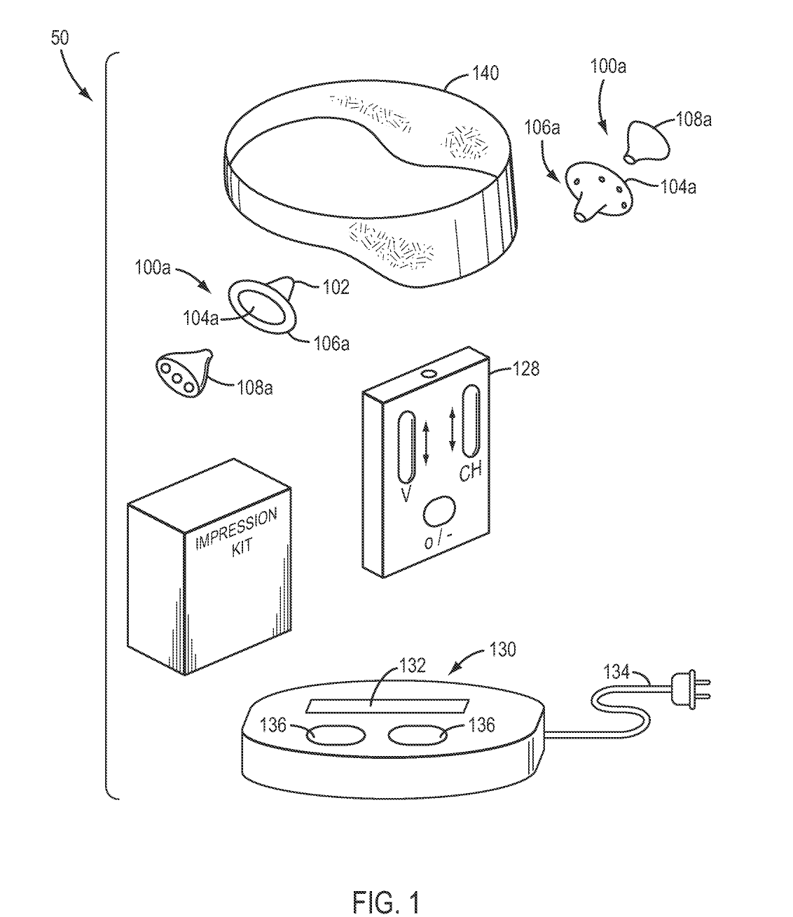

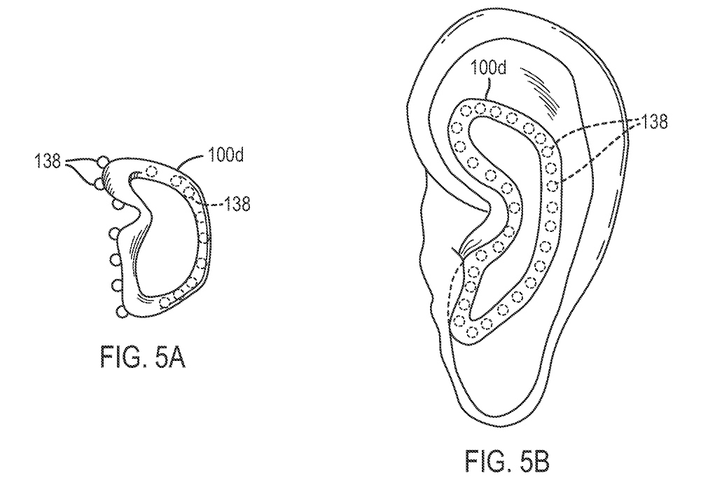

An exemplary embodiment of a sleep induction ear plug system 50 that can be used, for example, to induce and maintain a quality level of sleep, is illustrated in FIG. 1. In general, the ear plug system 50 can include a combination of various components to create an environment to facilitate a restful sleep for the user. In general, various embodiments of the ear plug system 50 can include one or more components such as an ear plug device 100a, 100b, and 100c for producing and controlling sounds, and stimulating acupuncture nodules 138 (FIGS. 5A-8) to apply pressure to selected points of the body, without piercing the skin, but which is still effective to alleviate symptoms of certain disorders; and a compressive headband 140, visor 170, headphone/muff design 164 or behind the ear device 168 for applying a slight pressure to assist with retaining the ear plug device and the acupuncture nodules 138 within the user's ear. In some embodiments, the acupuncture nodules 138 can be integrally designed within the ear plug device 100a, 100b, and 100c. In other embodiments, the acupuncture nodules 138 can be removably attached to the ear plug device 100a, 100b, and 100c. In some embodiments, the headband 140 can include an eye shade, shield, or visor 170, which can be fixed or movable between a raised and lowered position and designed for shielding and controlling the amount of light that reaches the user's eyes. The embodiments of the eye shade, shield, or visor 170 attached to the headband 140 can facilitate the interchangeability and secure fit of the acupuncture nodules and create a deep restful sleep.

As depicted in FIG. 1, in various embodiments, the ear plug device 100a can include at least a deformable body 106a and an electronic unit 108a for processing and transmitting sounds. The deformable body 106a can be configured having an open inserting end 102 to be inserted into a user's ear canal and an open inlet end 104a opposite to open inserting end 102. As shown in FIG. 1, the ear plug system 50 includes a pair of ear plug devices 100a, which are insertable into the user's left and right ear canal, respectively. In some embodiments, the electronic unit 108a can be removably inserted through the open inlet end 104a into a cavity of the deformable body 106a. In other embodiments, the deformable body 106a and the electronic unit 108a may be constructed and assembled as a unitary piece.

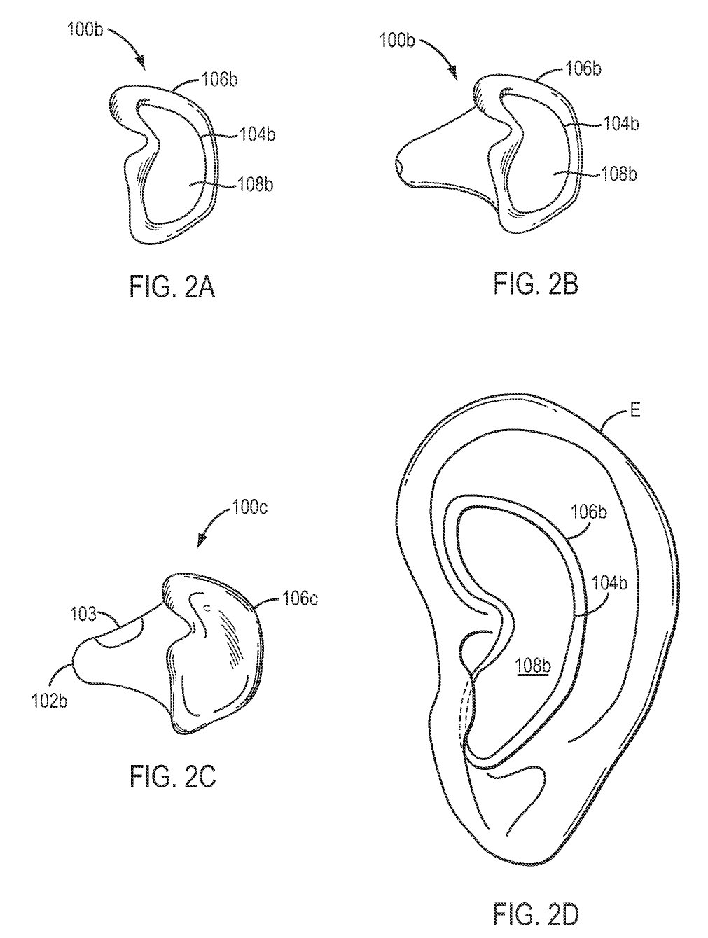

As illustrated in FIG. 1, in an exemplary embodiment of the ear plug device 100a, the open inlet end 104a of the deformable body 106a may be configured having a circular shape. In various exemplary embodiments of the ear plug device 100b shown in FIGS. 2A and 2B, however, the open inlet end 104b of the deformable body 106b may be defined having a non-circular shape for inserting the electronic unit 108b therein. In another exemplary embodiment of the ear plug device 100c (FIG. 2C), the deformable body 106c may have a solid end 102b defining a closed surface and an electrical compartment 103 capable of opening and closing for inserting the electronic unit (not shown) in a portion of the structure of the deformable body 106c insertable within the user's ear. FIG. 2D illustrates the ear plug device 100b inserted within the user's ear E.

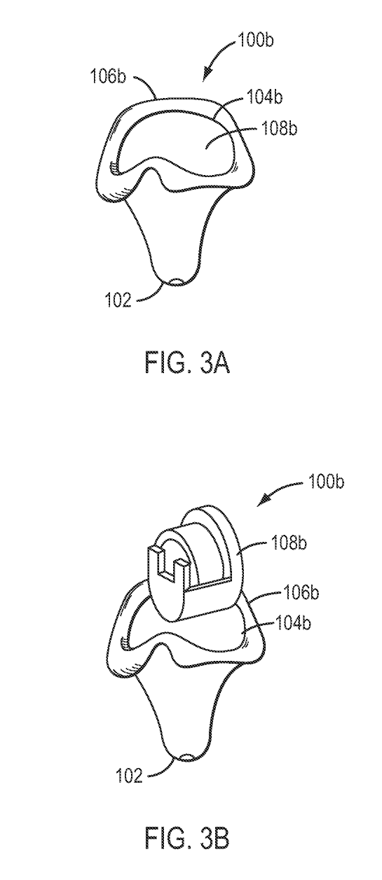

FIG. 3A illustrates a top view of the embodiment of FIGS. 2A and 2B. FIGS. 3B-3D illustrate the electronic unit 108b of the ear plug device 100b shown in the exemplary embodiment of FIG. 3A. The electronic unit 108a and 108b can include a sound processor formed from electronic components comprising a microphone 112, an electronic circuit 114, a speaker 116, and a battery 118. The microphone 112 is in electronic communication with the electronic circuit 114, and the electronic circuit 114 is in electronic communication with the speaker 116. Battery 118 provides the power source for the microphone 112, the electronic circuit 114, and the speaker 116 of the electronic unit 108a and 108b, which can be turned on or off by operating an on/off switch 120. In some embodiments, the battery 118 may be configured as a rechargeable battery that can be recharged when the ear plug device 100a, 100b, and 100c is mounted to a charging base 130, which is further discussed below. Alternatively, the power source can be a replaceable power source, such as a replaceable battery, similar to a hearing aid battery. As the power source operates to provide power to the electronic circuit 114 and other components, the electronic circuit 114 operates to process inputs received at the microphone 112 to produce output signals for the speaker 116. At the inserting end 102, the deformable body 106a, 106b, and 106c may include a sound transmitting opening 122 that enables sound waves propagated from the speaker 116 to enter the inside of the user's ear canal.

The electronic unit 108a and 108b can include a multi-processor system. The operation of the multi-processor system can be controlled by internal control software. The control software may include routines, programs, objects, components, and/or data structures that perform particular tasks that can be viewed as an operating system together with one or more applications. The operating system provides management and control functions which are utilized by the applications to offer user functions such as control of the ear plug device 100a, 100b, and 100c. The electronic unit 108a and 108b may further comprise an amplifier 124 and a white noise component 126. In general, sounds are received by the microphone 112, amplified, and transmitted to the ear of the user by the speaker 116. The microphone 112 generates an audio signal that is provided to the amplifier 124 for amplification and then the audio signal is transferred to the electronic unit 108a and 108b. A programmable remote control device 128 having control features to adjust volume levels, change settings, and/or select programs can be used in conjunction with the ear plug device 100a, 100b, and 100c for wireless transmission of signals to the ear plug device 100a, 100b, and 100c and other components of the ear plug system 50. The remote control device 128 can be programmable to add sound and therapeutic effects with numerous possible programming sequences. Using the programmable remote control 128, the user can design and save numerous different sequences. The remote control device 128 can be configured to playback, for example, programmed sounds, therapeutic acupuncture nodule sessions, and/or deep sleep induction sequences. Thus, the electronic unit 108a and 108b can operate in response to user selections, adjustments or preferences programmed, selected or entered by the user using the remote control device 128.

The programmable remote control device 128 (FIGS. 1, 9A, 9B, and 13) can be configured to wirelessly transmit remote control signals to control the ear plug device 100a, 100b, and 100c so that it can be controlled from a distance. Activation of the control features of the remote control device 128 by the user, such as pressing a button, rotating a thumbwheel, activating a touch-screen, or initiating voice activation, causes the remote control device 128 to transmit an infrared or radio wave remote control signal as a command to a receiver of the ear plug device 100a, 100b, and 100c for controlling it. The remote control device 128 can be configured with one or more buttons, such as adjusting the volume control, changing the channel of the preprogrammed sound or selecting the desired therapeutic acupuncture nodules, for controlling the functions of the ear plug device 100a, 100b, and 100c. Alternatively, in another embodiment, the ear plug device 100a, 100b, and 100c can be attached by a wire connection (not shown) to a processing unit within the remote control device, a charging base 130, or a computer.

In various exemplary embodiments, such as, for example, in the exemplary embodiments, the electronic unit 108a and 108b of the ear plug device 100a, 100b, and 100c can also include a white noise cancellation device 126. The white noise cancellation device 126 can be configured to cancel or mask unwanted noise and to provide particular sounds to the user. For example, the white noise cancellation device 126 can cancel extraneous noise and then the desired particular sounds, such as smoothing sounds or music, are transmitted via a speaker 116 to create a sleeping environment to induce sleep. The introduction of the masking sound by the white noise cancellation device 126 will make it easier for the user to fall asleep. The white noise cancellation device 126 can be configured and programmed such that the characteristics of the white noise matches and obscures extraneous noise. Thus, the white noise will mask the extraneous sounds and the introduction of the other sounds will make the user more relax and comfortable to fall into a deeper level of sleep, such as REM sleep. The soothing sounds or music can be mixed with or modulated by the white noise. Speaker 116 can be configured to generate the white noise and to produce the soothing sounds and music. In other embodiments, multiple speakers may be provided where one speaker generates the white noise, and another speaker generates the southing sounds and music. The white noise, soothing sounds, and music can be preprogrammed and digitally stored in internal memories of the processor, as well as downloaded and digitally stored onto external memories and then uploaded to the ear plug device 100a, 100b, and 100c either wirelessly through the use of remote control device 128 or through a wire connection (not shown). As used herein, the terms white noise, soothing sounds or music can include, but are not limited to natural sounds, computer-generated sounds and special effects, such as, for example, sounds of the ocean, a stream, rain, a waterfall, a babbling brook, and chirping birds. Any and all of these sounds can be provided within the ear plug system 50, as the above list is not an exclusive one. Using the control features of the remote control device, the user is able to select for play the white noise, soothing sounds, and/or music which is then emitted through the ear plug device 100a, 100b, and 100c and delivered into the user's ear to create a calm and restful sleep environment.

As shown in FIG. 1, the remote control device 128 can be configured to mate to the charging base 130 to receive power and/or communications. The charging base 130 may include a slot 132 for removably positioning the remote control device 128 therein. The remote control device 128 can include recharging contacts (not shown) provided to electrically couple with corresponding base contacts (not shown) included within the slot 132 of the charging base 130. The charging base 130 may comprise a power source 134 such as, for example, an electrical socket. The foregoing configurations enable the remote control device 128 to interface with and control the ear plug device 100a, 100b, and 100c. In the preferred embodiments, the remote control device 128 interfaces with the ear plug device 100a, 100b, and 100c wirelessly. In other embodiments, the remote control device 128 can be configured to interface with the ear plug device 100a, 100b, and 100c via a physical connection. The charging base 128 may also include docketing slots 136 for removably housing the ear plug device 100a, 100b, and 100c within the charging base 130. In the embodiments where the ear plug device 100a, 100b, and 100c employs a rechargeable battery, the ear plug device 100a, 100b, and 100c may include recharging contacts (not shown) and the docketing slots 136 may include corresponding base contacts (not shown) which mate when inserted within the charging base 130 to recharge the rechargeable battery of the ear plug device 100a, 100b, and 100c.

Ear Plug-Shape and Material

While ears may vary in size and shape from person to person, the material and the shape of the ear plug device 100a, 100b, and 100c are selected to comfortably fit inside most adults' ears to provide a good seal against external noises. The deformable body 106a, 106b, and 106c can be made of a soft and pliable material that is configured having a shape of an ear piece, which conforms to the shape of the entrance of the user's ear. The ear piece of the deformable body 106a, 106b, and 106c can be made, for example, of a recovery foam, which is capable of being compressed to permit the inserting end 102 to be slightly inserted into the user's ear. When the pressure is released, the ear piece of the deformable body 106a, 106b, and 106c will attempt to recover its original shape and size such that it will create a seal against the user's ear to block external sounds from entering into the user's ear canal. It is noted that any flexible, pliable material which can be formed so as to result in an ear piece meeting the design criteria set forth herein constitutes a satisfactory material of construction in the ear plug device 100a, 100b, and 100c of the present teachings. Accordingly, polymers can be generally employed. In the exemplary embodiments in FIGS. 1, 2B, and 2C, the inserting end 102 can be configured having an extending tube that protrudes outwardly to fit within the user's ear canal to a depth sufficient to position the white noise cancellation device 126 therein to create a restful environment by assisting with blocking out external noise and introducing peaceful, soothing sounds and music. In some embodiments, the ear piece of the deformable body 106a, 106b, and 106c can be configured as a standard, off-the-shelf component that fits the ears' of most adults. In other embodiments, the ear piece of the deformable body 106a, 106b, and 106c can be custom configured to specifically match the shape of the user's ear to provide greater comfort and a better seal. It should be understood that the shape and material of the ear plug device 100a, 100b, and 100c depicted and described herein are exemplary only and those having ordinary skill in the art would appreciate that a variety of shapes, sizes, materials, and arrangements of parts may be substituted for or used in conjunction with the ear plug device 100a, 100b, and 100c.

II. Acupuncture Nodules

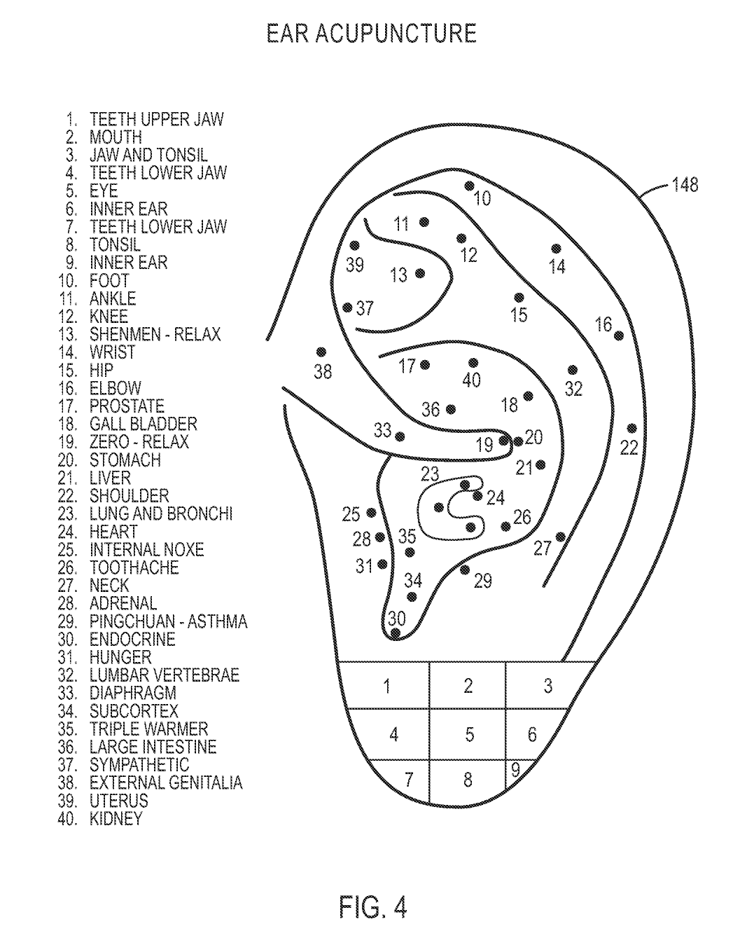

Various embodiments of the ear plug device 100a, 100b, and 100c are designed to include acupuncture nodules 138 for the application of acupuncture, without puncturing the skin, for alleviating symptoms associated with certain disorders or conditions. Acupressure is the application of pressure to selected points of the body, such that the pressure is not sufficient to pierce the skin, but which is still effective to alleviate symptoms of certain disorders. The acupuncture nodules 138 can be configured having different patterns based on an acupuncture/acupressure diagram or map 148 of an external ear or an auricle similar to that shown in FIG. 4. In FIG. 4, the entire body is represented in general in the diagram of the auricle such that stress and pain in other parts of the body can be relieved by stimulation of the acupoints on the surface of the ear. The pattern of the acupuncture nodules 138 can be configured and mapped to correspond with acupoints in a specific region in the external ear. As shown in FIGS. 5A, 5B, 6A, 6B, 6C, 7 and 8, the ear plug device 100a, 100b, and 100c can be configured in various embodiments as an ear plug device 100d, 100e, 100f, and 100g that includes one or more acupuncture nodules 138 which provide stimulation to one or more acupoints of the user's ear. The ear piece device 100d, 100e, 100f, and 100g can be designed having various acupuncture nodule configurations. In some exemplary embodiments, the ear piece device including the acupuncture nodules can be configured to contact, cover, and stimulate portions of the ear, such as shown in the exemplary embodiment in FIGS. 5B, 7, and 8. The ear plug device 100d depicted in the exemplary embodiment of FIG. 5A are shown with acupuncture nodules 138 that are formed integrally within the outer edge of the ear plug device 100d and cover to stimulate the acupoints located at the entry of the user's outer ear canal. FIG. 5B illustrates ear plug device 100d of FIG. 5A inserted in the entry of the ear canal of the user's ear. The nodal patterns can be designed having various configurations to apply pressure to one or more acupoints located at the outer ear canal. For example referring to the ear acupuncture diagram of FIG. 4, the nodule patterns can be configured to relieve stress and pain in the liver (point 21), lung and bronchi (point 23), heart (point 24), and/or a toothache (point 26). Stimulation of the user's acupoints can be performed either by manually or electronically activating the ear plug device 100d. In a manual embodiment, the user can stimulate the acupuncture nodules 138 by manual application of pressure to the ear plug device 100d. In an electronic embodiment, electronic components of the ear plug device 100d can be employed to control activation of the acupuncture nodules 138 to provide stimulation to the acupoints in the user's ear.

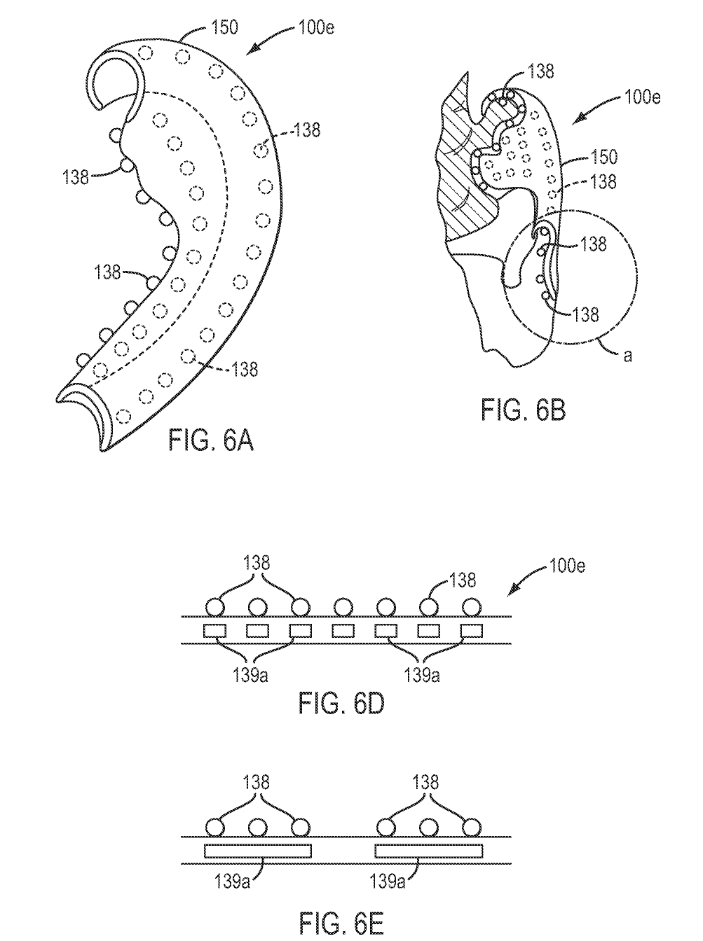

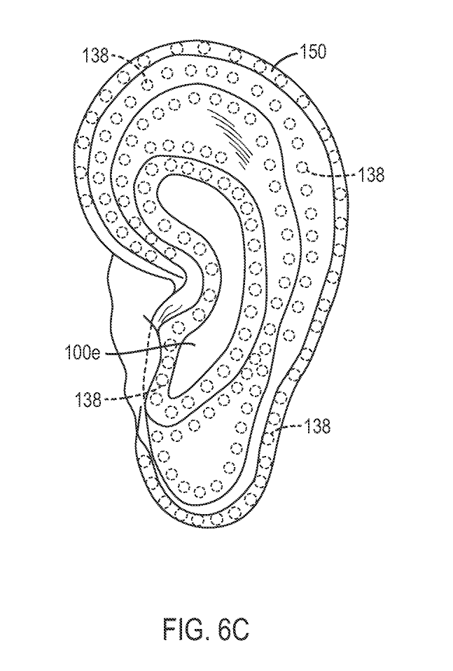

In the electronic embodiment, conductive wires are configured within the ear plug device and electrically connect to each of the acupuncture nodes 138. When activated, electricity can be supplied to each individual nodule or a plurality of select nodules to provide various levels of stimulation to sections of the user's ear. FIG. 6D shows a cross-sectional view of the ear plug device 100e of FIG. 6B comprising individual stimulating devices 139a for slightly stimulating a bottom of each respective nodule 138 when the stimulating device 139a is activated. The nodules 138 are mounted on the stimulating device 139a. Similarly, FIG. 6E illustrate stimulating devices 139b that stimulate a group of nodules. Stimulation of the stimulating devices 139a, 139b can be provided in various manners, such as through vibration or rotation of the stimulation devices. The stimulating devices are electrically connected to a power generating mechanism, by way of one or more of a wiring plate, circuit board, a switch or battery. The specific electrical wiring of the stimulating devices 139a, 139b have been omitted for the sake of clarity.

In some embodiments, the ear plug device 100e can be configured to cover the entire front of the user's ear as shown, for example, in FIG. 6C. In other words, the ear piece device 100e can be configured to contact, cover, and stimulate the entry of the ear canal and substantially all of the outer front surface of the pinna including the helix, antihelix, antitragus, tragus and the lobe of the ear. FIGS. 6A, 6B, and 6C illustrate the ear plug device 100e having an ear cover 150 that slips onto the user's ear such that the acupuncture nodules 138 contact the acupoints of the user's ear. In some embodiments, the ear cover 150 may be integrally formed with the ear plug device 100e as a unitary piece. In other embodiments, a connection mechanism may be included to connect the ear cover 150 to the ear plug device 100e. The connection mechanism will be described in further details below. As mentioned above, the acupuncture nodules 138 can be configured having a variety of nodule pattern configurations for the application of pressure to acupoints within the user's external ear to relieve pain located in another location of the user's body. In various exemplary embodiments, the acupuncture nodules 138 can be designed to relieve a specific condition or disorder such that the configuration of the nodule pattern can be selected based upon the condition or disorder. Different disorders or conditions have different locations of acupoints which are to be stimulated for the acupuncture to be effective, as shown on FIG. 4. In the embodiments which include the connection mechanisms, the ear cover 150 of the ear plug device 100e can be interchangeable with different nodule patterns 150 that can be inserted on and removed from the ear plug device 100e. For example, the ear cover 150 in accordance with various exemplary embodiments of the present teachings may include acupuncture nodules 138 having nodule patterns to address obesity, to aid in quit smoking, and to prevent nausea and vomiting. The ear cover 150 can be manufactured as an off-the-self component made from a thin, transparent material, such as a thin piece of plastic. In some embodiments, the ear cover 150 can be custom-fitted or form-fitted to the individual shaper of the user's ear. In both off-the-shelf and custom-fitted embodiments, the ear cover 150 can be manufactured from translucent or opaque materials that are colored to match with the skin tone of the wearer. Generally, the ear cover 150 is formed to assume the shape of a portion (FIGS. 5B, 7 and 8) or substantially all of the user's outer ear (FIG. 6C). The ear cover 150 is formed and/or molded to fit the contours of the user's ear. During use, the ear cover 150 is pulled onto, hooked onto, or clipped onto the user's ear.

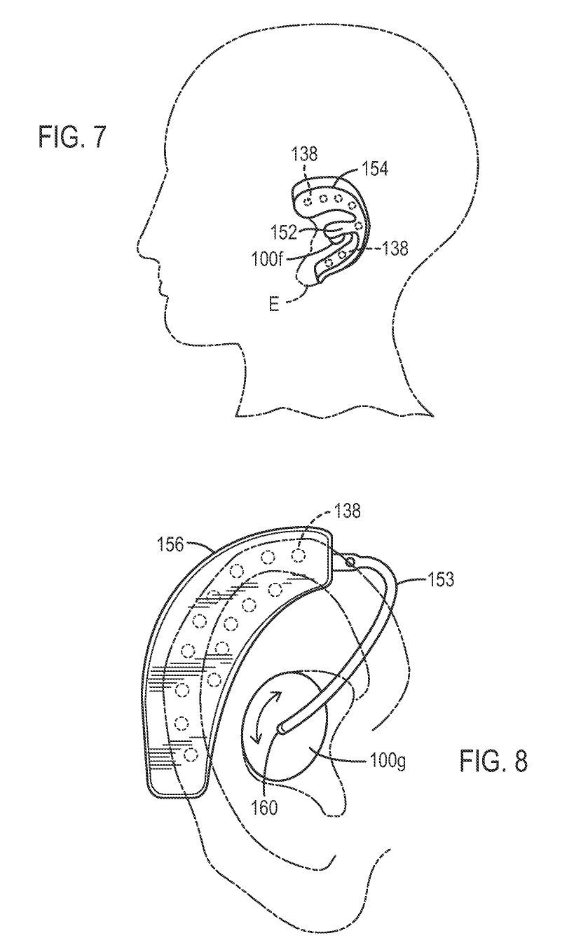

FIG. 7 illustrates the ear plug device 100f having a clip-on/snap-on attachment mechanism 152. In the exemplary embodiment, the ear cover 154 is configured having a one-piece channeled body formed of resilient material, which is adapted to snugly engage the front of the ear and the back of the ear. For example, the ear cover 154 may include a resilient clamping member 152 adapted to project inwardly substantially at the center of the user's ear and the clamping member 152 is formed such that it will resiliently contact with and grip the adjacent surface of the back. During use when the ear cover 154 is applied to the user's ear, the clamping member 152 is biased inwardly to snugly fit the ear cover 154 onto the user's ear such that there is a comfortable but relatively tight fit between the device and the ear. The ear cover 154 and the clamping member 152 may be formed integrally with the ear plug device 100f. Alternatively, the clamping member 152 and the ear cover 154 may be configured as separate elements that are mechanically and/or adhesively secured to the ear plug device 100f. Similar to the embodiments described above, the ear cover 154 can be configured having acupuncture nodules 138 with a variety of nodule pattern configurations for the application of pressure to acupoints on the user's external ear to relieve pain located in another location of the user's body. In the embodiments of FIGS. 7 and 8, the acupuncture nodules 138 of the ear cover 154 can be designed to relieve a specific conditions or disorder such that the configuration of the nodule pattern can be selected based upon the condition or disorder. The ear plug device 100f and 100g can be configured having an interchangeable ear cover 154 with differing nodule patterns selected and positioned on a specific location of the user's ear based upon the condition or disorder desired to be treated. In use, should the user desire to change the ear cover 154, the ear cover 154 is conveniently and interchangeably attached to the ear plug device 100f through a variety of attachment means, such as a simple snap-on, clip-on, pull-on, press-fit, tongue-and-groove, or slide-and-lock arrangement.

FIG. 8 illustrates the ear plug device 100g having a ear cover 156 with a moveable element 158 that is pivotally and/or rotatably attached thereto. Using the moveable element 158, the ear cover 156 can be rotated or moved such that the acupuncture nodules 138 can be applied to various positions along the user's ear to address different conditions. FIG. 8 illustrates the ear plug device 100g shown with the ear plug device 100g inserted in the entry of the ear canal of the user's ear and with a rotating snap-on design of the moveable element 158. For example, the moveable element 158 may include an attachment mechanism having a protrusion (not shown) that snaps into a receiving cavity 160 provided in the ear plug device 100g. The rotatable mounting allows the user to vary the position of the ear cover 156 by rotating the attachment means to stimulate various acupoints located on the user's ear. As discussed above, the ear plug device 100g may be configured having interchangeable ear covers with various nodal patterns. The interchangeable ear covers 156 contacts the user's ear and applies pressure, without penetrating the skin, to provide therapeutic effects to stimulate acupuncture points to provide relief of the symptoms of certain conditions.

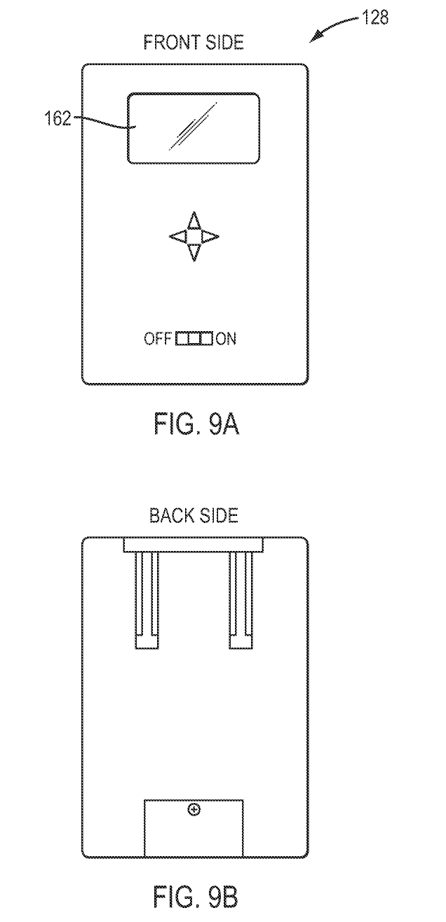

It should be understood that the ear plug devices depicted in FIGS. 5A, 5B, 6A, 6B, 6C, 7 and 8 are exemplary only and those having ordinary skill in the art would appreciate that a variety of designs having differing configurations and nodal patterns may be substituted for or used in conjunction with the ear plug devices. The plurality of nodal patterns may include nodal patterns of the same or differing configurations. Moreover, configurations and number of the acupuncture nodules 138 may be selected so as to stimulate one or more desired acupoints, as discussed above, for example, depending on the body part or symptoms associated with one or more conditions that the user wishes to address. Stimulation of the acupuncture nodules 138 against the user's ear may be implemented either manually or electronically. In a manual embodiment, the user selects the desired acupuncture therapy by placing one of the interchangeable ear covers 150, 154, 156 onto the ear plug device. The user can stimulate the acupuncture nodules 138 for approximately 5-20 minutes by the manual application of pressure to the ear plug device. In an electronic embodiment, the use of the ear plug device in conjunction with the remote control device 128 provides a device and method of electronically controlling the acupuncture nodules 138 to provide stimulations to the acupoints in the user's ear. The device can be configured such that electrical manipulation of the acupuncture nodes 138 can be accomplished by employing various well-known techniques, for example, such as those incorporated in electrical massagers having nodes. The acupuncture nodes 138, which can be configured to function similar to a messaging element, preferably can be made of sponge rubber or other material suitable for body contact and substantially spherical in shape. In some of the electronic embodiments, the nodule patterns of a single ear cover 150, 154, 156 may be configured to address one or more conditions or disorders. In other embodiments, the same ear cover 150, 154, 156 may be configured with a plurality of acupuncture nodules 138 that can be selectively activated, through the use of the remote control device 128, to select the appropriate nodule pattern that corresponds to a particular condition or disorder. The remote control device 128 can illustrate on a display 162 (FIGS. 9A and 9B) a searchable listing of the acupuncture/acupressure points and/or a navigable map of the acupuncture/acupressure points of the external ear or auricle as illustrated in FIG. 4. Furthermore, the remote control device 128 can be programmed or can be configured with preprogrammed settings to provide nodal stimulation sequences and verbal instructions or visual illustrations shown on the display to the user, such as desirable body positions, breathing rhythms or patterns that may further enhance a deep restful sleep.

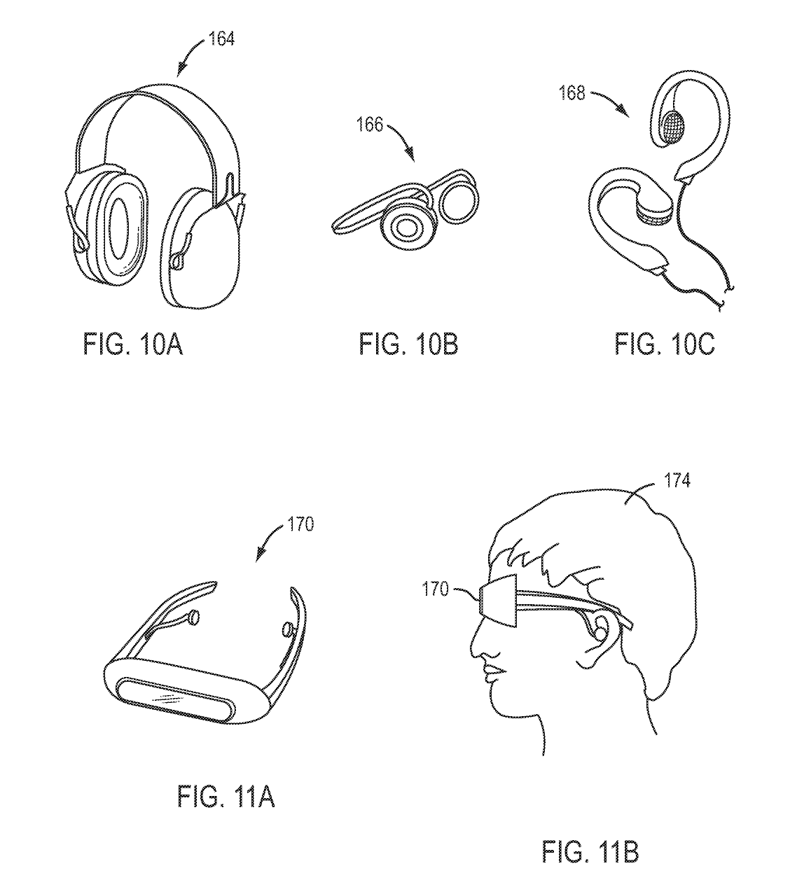

In various embodiments, the ear plug device can be designed having configurations without or with the acupuncture nodules 138. For example, the ear plug device can be designed similar to a Behind-the-Ear hearing device 166, 168 (FIGS. 10B, 10C), an ear-muff/headphone design 164 (FIG. 10A, 10B) such that the nodule configurations cover the entire external ear to provide a wider coverage area of stimulation or an ear plug device 170 (FIGS. 11A and 11B) having an electronic controllable visor or manually moveable visor designed for shielding and controlling the amount of light that reaches the user's eyes (FIG. 8B). In various embodiments, the acupuncture nodules 138 can be integral with the ear plug device to be a single component. In an electronic version, the electronic controllable visor can be remotely controlled using the remote control device 128 to control and change the amount of light permitted to reach the user's eyes and to display, for example, serene scenery to facilitate creating a deep restful sleep environment for the user. In some embodiments, in conjunction with or as an alternative to the application of pressure of the nodules described above, the acupuncture therapy can be provided to the user through infrared or vibration applications. These exemplary designs can be configured such that they are either manually or electronically activated and controlled.

Headband

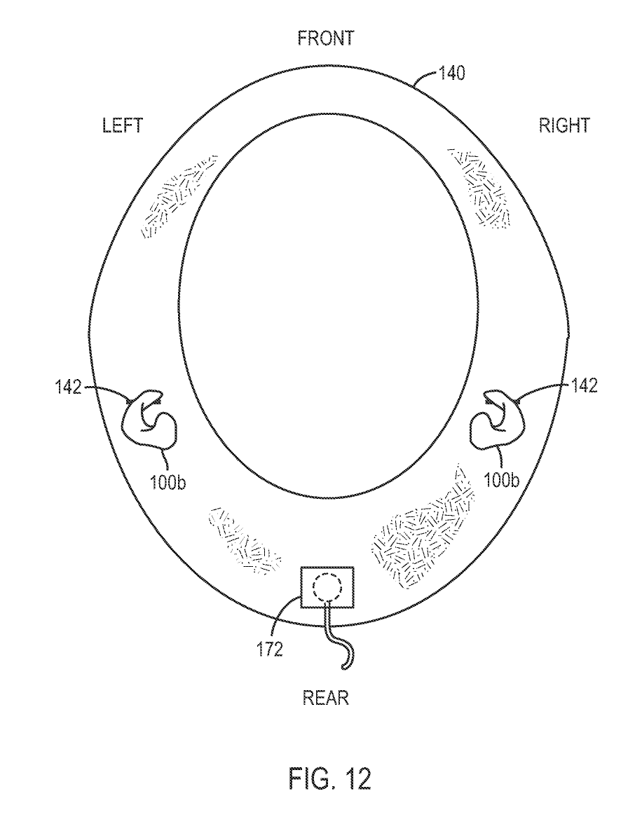

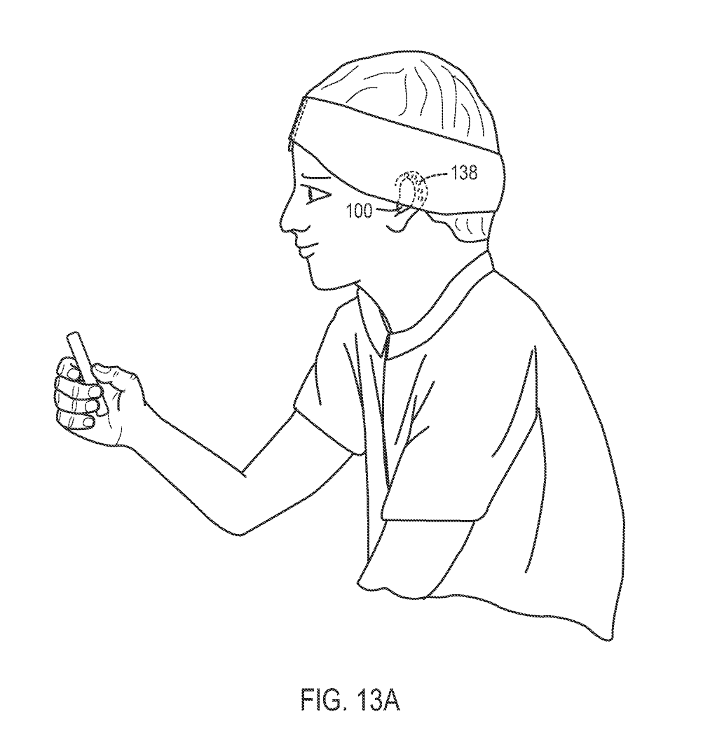

As shown in FIGS. 1 and 12, various embodiments of the ear plug system 50 can include a headband 140 that will create additional pressure to aid in positioning the ear plug device, with or without the acupuncture nodules 138, when attached. The headband 140 is shaped to maintain an effective force toward the ear canal such that, for example, the ear plug device 100b may be substantially or fully disposed against the user's ear canal and provide a secure fit to the ear canal. The headband 140 holds the ear plug device against opposing sides of the user's head at the respective ears. The compressive force of the headband 140 provides comfortable tension to fit all head sizes. In some embodiments, the headband can include an eye shade, shield or visor, shown for example in FIGS. 11A and 11B, which can be moved in the line of sight of the user, to shield or block the amount of light that reaches the user's eyes in order to create a peaceful and restful sleep environment. The eye shade, visor, or shield can be configured integrally attached or removably attached to extend downward from the headband so that it can be positioned in front of a wearer's eyes. The eye shade, shield, or visor may have a nosepiece or bridge shaped to accommodate nose bridges of various sizes and shapes of the user.

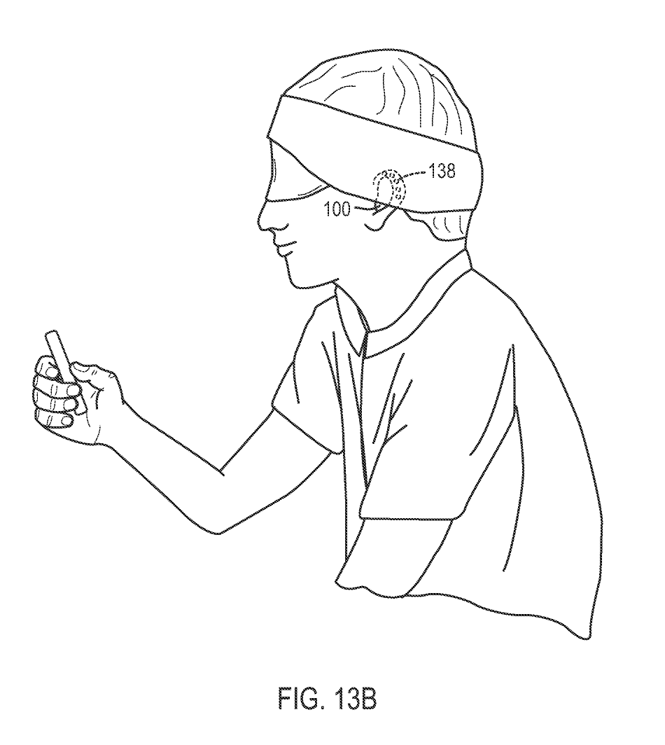

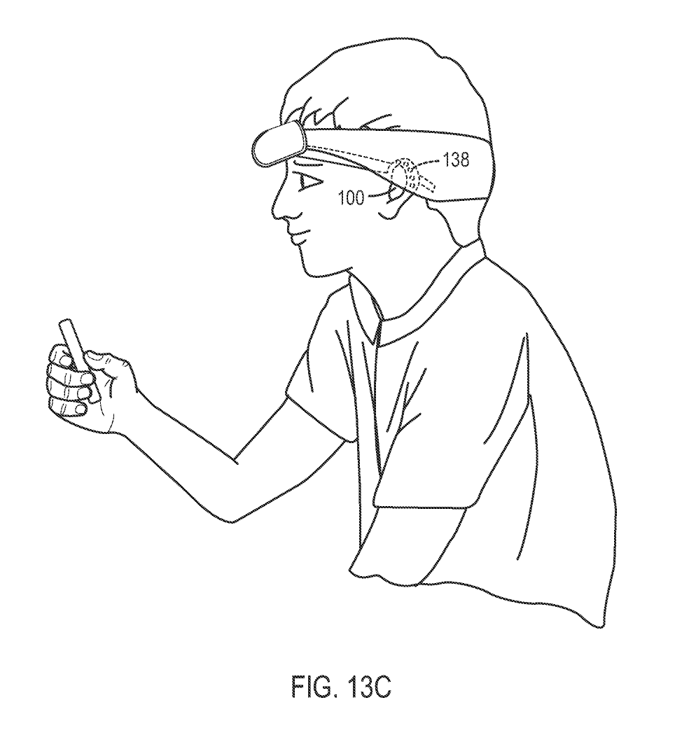

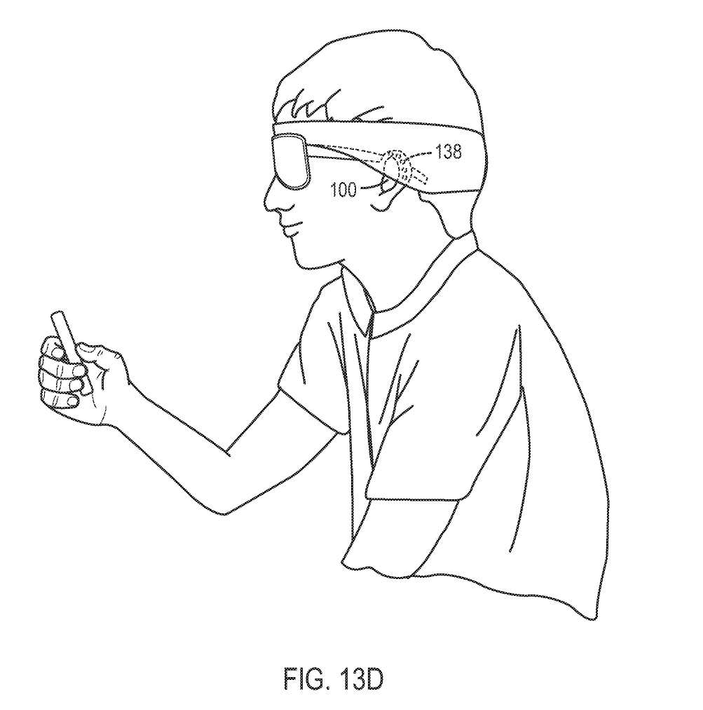

In the exemplary embodiment of FIGS. 1 and 12, the headband 140 may be manufactured from a material that may be elastic and as such form a continuous band extending around the head. The stretch of the elastic material provides comfort to the user while keeping the device in place. In use, the ear plug device 100b, with or without acupuncture nodules, can be inserted into slits 142 provided in the headband. The user then stretches and pulls the headband 140 downward over his or her head such that the headband 140 causes the ear plug devices to be positioned adjacent to and pressed against the ears of the user to receive the sound produced by the battery-operated 172 ear plug device 100b and/or to receive the acupuncture stimulation provided by the acupuncture nodules 138. In another embodiment, the headband 140 may include an opening located anywhere on the front or back and include VELCRO® as a fastening device on each end of the opening to be adjustably secured to fit a number of sizes of heads. In an alternative arrangement, the two ends of the headband 140 may be connected with an appropriate means of attachment, thus further securing the ear piece devices 100b into the user's ear. Exemplary means of attachment may include, for example, ribbons to be tied together, buttons, hooks, and snaps. FIGS. 13A-13B illustrate the device in use with a headband. FIGS. 13C-13D illustrate the device in use with a visor.

It is understood that a kit comprising a box housing an ear plug system is within the scope of the invention. The invention can include a variety of kits combining different parts of the invention. One exemplary kit may include a container holding a pair of ear plugs, an electronic device, and a head band. Another kit may include a pair of ear plugs, an electronic device, a head band, and a neck pillow 174. The neck pillow may include an inflatable bladder having a manual inflation valve by which the user can blow up and inflate the bladder such that it expands outwardly to form a comfortable neck and head support for the user to be used in combination with the other components of the kit to create a peaceful and restful environment. Another embodiment of the kit may include a pair of ear plugs, an electronic device, a head band, a neck pillow, and a visor. The visor may be used in conjunction with the other components to block out sound and light and create a comfortable rest environment. Other embodiments of the kit may include any combinations of any parts of the invention.

Custom Embodiment

The very best sound seal between a device and the user's ear can be obtained with a custom fit ear device, because each person's ears have a unique shape, which are as unique as are his fingerprints. Generally, custom fitted ear devices are made by taking an actual impression of each individual ear and subsequently casting ear devices having a perfect fit for the ear. In such a custom fitted device a complete sound seal between the ear and the device is obtained and the device tends to be quite comfortable when in use. According to the present teaching, the ear plug device 100, the ear cover 150 or both can be provided as custom-fitted or form-fitted devices. Such specially custom-formed devices can be manufactured onsite and be immediately distributed to a patient by medical doctors, audiologists, professional technicians, and the like.

Custom Ear Prosthesis Cover

In various embodiments, the ear cover 150 can be provided as a device that is custom-fitted or form-fitted to the individual shape of the wearer's ear. The ear cover 150 can be a very thin, transparent malleable material, such as a thin piece of plastic, having one or more nodules provided therein. For example, in embodiments that include the acupuncture nodules 138, a known standard meridian acupuncture point detector or auricular electrical point locater, such as the Point Mate™ Acupuncture Point Detector, can be used to accurately locate the acupuncture points which are to be stimulated. Such point locaters and their use are well known to those in the field of acupuncture. To implement this exemplary embodiment, the auricular acupuncture points are selected based on the condition or disorder of the user to be addressed. The selected acupuncture points are located and marked on the surface of the user's ear with a surgical ink marker available, for example, from Viscot™ Medical, LLC. The ear cover 150 can be soaked in hot water or otherwise heated until it becomes malleable or bendable. The ear cover 150 can be applied to the ear and then bent, shaped, or molded to conform to the contours or comfort level of the wearer such that the points marked with the surgical ink marker will be transferred and imprinted on the malleable material. Before the malleable material of the ear cover 150 hardens, the acupuncture nodules 138 can be embedded in, affixed to, and/or molded in the malleable material. For example, in some embodiments, one or more nodules can be inserted in the malleable material such that the nodules are embedded in the solidifying material accurately at the marked acupuncture point locations. The nodules, for example, may include a spherical shaped protrusion, such as, but not limited to, a bead, a rounded mass, or a projection. In other embodiments, the acupuncture nodules 138 can be formed or molded in the malleable material. For example, after the ear impression is formed and before the material hardens, projections can be indented on the surface of the material at the exact marked acupuncture point locations. An indention device, such as a pointy object or a pin, can be applied to the malleable material to form one or more projections that protrude from the surface of the malleable material. After the nodules are embedded in, affixed to, and/or molded therein, the malleable material is finally hardened to form the ear cover 150.

In the devices prepared by an audiologist or professional technician, electrical components may be further embedded within the device to connect to and to selectively operate each individual node or a selected group of nodes.

Custom Earmold

Various embodiments of the present teachings provides a custom-fitted or a form-fitted ear plug device 100. In a custom-fitted or form-fitted embodiment, a custom ear plug device 100 can be made as an earmold formed from a soft, flexible elastic plastic having an inwardly extending conical portion adapted to fit into the concha and outer portion of the auditory canal. Earmold devices of the invention may be made from any soft, flexible material and are preferably made of a medical grade material desirable for its biocompatibility and is hypo-allergenic. For example, the ear mold can be made of a flexible, elastic, fast-setting silicone material having a density after curing of approximately 0.5-3.0 gm/cc. The ear mold can be formed using conventional methods of fabricating hearing aid devices. These fast-setting silicone material, such as dental impression material, and techniques were adopted from the dental industry. The silicone material can be mixed and inserted directly into the external auditory canal to take an impression of the individual's ear. The micro-miniaturized electronic components can be embedded before the silicone material completely cures. After removal of the ear mold from the individual's ear, the ear mold can be further cured, if necessary, by any of the conventional curing methods. Upon curing, the ear mold hardens to a flexible mold to permanently retain the shape of the individual's ear. In some embodiments, the electronic components can be embedded into the mold after removal of the earmold from the user's ear.

Those skilled in the art would recognize a variety of techniques and materials that may be used to make the custom prosthetic designs of the ear cover 150 and/or the ear plug device 100. A doctor, audiologist, technician and/or the user can accomplish these molding procedures. The ear cover 150 and the ear plug device 100 may be easily adjusted or modified to provide a wide variety of different sizes and thereby accommodate the needs of a larger consumer base.

Do-It-Yourself Kit

In various embodiments, the custom ear plug device 100 can be sold to the user as a “do-it-yourself” kit. In such an embodiment, the silicone material may be provided in the kit as two separate ear impression putties having two different colors and stored in two separate containers. When the user kneads the two putties together, this will cause a reaction which will begin the silicone material to set. The user should knead the two putties together until the colors blend into one solid color. Now, the ear impression putty is ready to be inserted into the individual's ear. The user should divide the ear impression material evenly into two equal portions. One portion should be slowly and carefully put in each ear, pushing lightly but firmly. The impression material should completely fill the area between the ear canal. Therefore, the user should fold in any excess material to create a good fit. Then, slowly but firmly, insert into the impression material any micro-miniaturized electronic components provided in the kit. Gently press the impression material such that it surrounds the electrical components so that it forms a good seal. After approximately 5-10 minutes, the impression material becomes firm to the touch, and it will have set enough so that the earmold can be removed from the user's ear by slowly and gently pulling on the edges of the earmold.

Conclusion

As explained above, the several customized devices described herein are designed to provide both greater comfort in the user's ear and a better seal between the ear and the device. An alternative to the custom fit ear devices is a universal ear cover 150 and/or ear plug device 100 made in several sizes and having a portion thereof inserted into the ear canal means for effecting a complete sound seal without creating discomfort. Thus, standardized sizes and shapes of the ear cover 150 and/or ear plug device 100 can be manufactured for mass distribution to provide a more generally fitted device. To accommodate a variety of ear sizes and active lifestyles, the ear cover 150 can be manufactured with a wide variety of attachment mechanisms to fasten the ear cover to the user's ear and/or to the ear plug device 100.

It will be apparent to those skilled in the art that various modifications and variations can be made to the ear plug system and method of the present disclosure without departing from the scope its teachings.

Other embodiments of the disclosure will be apparent to those skilled in the art from consideration of the specification and practice of the teachings disclosed herein. It is intended that the specification and examples be considered as exemplary only.

What is claimed is:

1. An ear plug system, comprising:
an ear plug device configured to be inserted into a user's ear, comprising:
a sound producing mechanism configured to produce sounds and transmit the sounds within the user's ear when inserted into the user's ear;
a white noise generator included in the sound producing mechanism and configured to generate noise-cancellation sounds in an interior of the ear plug device to mask or cancel select external noises;
an ear cover to cover a portion of the user's ear;
at least one acupuncture nodule provided in the ear cover and configured to apply pressure on the user's ear, without penetrating the user's skin; and
a headgear configured to extend at least partially around the user's head and apply a compressive force to the ear plug device and the acupuncture nodes; and
an electronic control unit connected to the ear plug device for controlling operation of the ear plug device.

2. The system of claim 1 further comprising a remote control device in wireless or direct communication with the electronic control unit, wherein the remote control device is configured to enable the user to set at least one operational parameter of the electronic control unit to control the ear plug device.

3. The system of claim 2, wherein the remote control device communicates with the electronic control unit through a direct connection, a wireless transmitter or a wired connection.

4. The system of claim 3, wherein the remote control device controls the sounds produced by the sound producing mechanism and controls stimulation of the at least one acupuncture nodules to apply pressure to the user's ear.

5. The system of claim 1, wherein the sounds produced by the sound producing mechanism is selected from at least one of a white noise, music, and a pre-recorded nature sound that can be programmed and digitally stored in internal memories of at least one processor of the ear plug system.

6. The system of claim 5, wherein the pre-recorded nature sound is selected from a group consisting of an ocean sound, a rain sound, a waterfall sound, a brook sound, a stream sound, and a chirping bird sound.

7. The system of claim 1, wherein a portion of the headgear is adjustable to movable between a raised position and a lowered position for adjusting an amount of light permitted to penetrate the headgear.

8. The system of claim 1, wherein the headgear comprises at least one of a headband, a visor, a shade or a shield.

9. The system of claim 8, further comprising a remote control device to control the headgear to adjust the amount of light permitted to penetrate the headgear selected from the group consisting of: the visor, the shade and the shield.

10. The system of claim 1, wherein the at least one acupuncture nodules is integral with the ear plug device or removably attached to the ear plug device.

11. The system of claim 10, wherein the at least one acupuncture nodule can be configured having at least one pattern based on an acupuncture diagram of an external ear and corresponding with acupoints in a specific region in the external ear as identified on the acupuncture diagram.

12. The system of claim 1, wherein stimulation of the at least one acupuncture nodule is performed manually, electronically or a combination thereof.

13. The system of claim 12, wherein the at least one acupuncture nodule comprises individual stimulating devices for activating respective acupuncture nodules.

14. The system of claim 12, wherein the at least one acupuncture nodule is configured as a group of stimulating devices for activating respective acupuncture nodules defined as a group of acupuncture nodules.

15. The system of claim 12, wherein the stimulation of the at least one acupuncture is performed by applying pressure, vibration, rotation, infrared or a combination thereof.

16. The system of claim 1, wherein the ear cover comprises a plurality of interchangeable ear covers for covering the portion of the user's ear such that the at least one acupuncture nodule contacts acupoints of the user's ear, wherein each interchangeable ear cover has a different nodule pattern.

17. The system of claim 16, wherein each nodule pattern is selected based on an acupuncture diagram of an external ear and corresponding with acupoints in a specific region in the external ear as identified on the acupuncture diagram.

18. The system of claim 17, further comprising a remote control device in wireless or direct communication with the electronic control unit, wherein the remote control device is configured to enable the user to set at least one operational parameter of the electronic control unit to control application of the pressure of the acupuncture nodule identified in at least one of the specific regions.

19. A kit for assembling an ear plug system to create a restful environment for a user, comprising:
an ear plug device configured to be inserted into a user's ear, comprising:
an elastically deformable body configured such that a mold is moldable and solidifies to maintain its shape to permanently form an open inserting end to be inserted into an inner region of the user's ear and an open inlet end opposite to the open insertable end and positioned at an outer region of the user's ear;
providing a sound producing mechanism removably insertable into the deformable body and configured to produce sounds and transmit the sounds within the user's ear when inserted into the user's ear;
providing a white noise generator included in the sound producing mechanism and configured to generate noise-cancellation sounds in an interior of the ear plug device to mask or cancel select external noises;
providing an ear cover to cover a portion of the user's ear;
providing at least one acupuncture nodule in the ear cover and configured to apply pressure on the user's ear, without penetrating the user's skin; and
providing a headgear configured to extend at least partially around the user's head and apply a compressive force to the ear plug device and the acupuncture nodes; and
an electronic control unit comprising at least a remote control device in communication with the ear plug device for controlling operation of the ear plug device.

20. A method of providing an ear plug system to create a restful environment for a user, comprising:
inserting an ear plug device into a user's ear, the ear plug device comprising:
an elastically deformable body configured such that a mold is moldable and solidifies to maintain its shape to permanently form an ear plug device comprising an open inserting end to be inserted into an inner region of the user's ear and an open inlet end opposite to the open insertable end and positioned at an outer region of the user's ear;
a sound producing mechanism removably insertable into the deformable body and configured to produce sounds and transmit the sounds within the user's ear when inserted into the user's ear;
a white noise generator included in the sound producing mechanism and configured to generate noise-cancellation sounds in an interior of the ear plug device to mask or cancel select external noises;
an ear cover to cover a portion of the user's ear;
at least one acupuncture nodule provided in the ear cover and configured to apply pressure on the user's ear, without penetrating the user's skin; and
a headgear configured to extend at least partially around the user's head and apply a compressive force to the ear plug device and the acupuncture nodes; and
controlling operation of the ear plug device using an electronic control unit comprising at least a remote control device in communication with the ear plug device.
